(19) United States
(12) Patent Application Publication
(10) Pub. No.: US 2025/0293967 A1
(43) Pub. Date: Sep. 18, 2025

(54) VEHICLE CONTROL APPARATUS AND METHOD THEREOF

(71) Applicants: HYUNDAI MOTOR COMPANY, Seoul (KR); KIA CORPORATION, Seoul (KR)

(72) Inventor: Hae Ri Kim, Hwaseong-si (KR)

(73) Assignees: HYUNDAI MOTOR COMPANY, Seoul (KR); KIA CORPORATION, Seoul (KR)

(21) Appl. No.: 18/796,662

(22) Filed: Aug. 7, 2024

(30) Foreign Application Priority Data
Mar. 15, 2024 (KR) 10-2024-0036657

(51) Int. Cl. H04L 45/02; B60R 16/023; H04L 67/12; H04W 4/48

(52) U.S. Cl. CPC H04L 45/02; B60R 16/023; H04L 67/12; H04W 4/48

(57) ABSTRACT

A vehicle control apparatus includes a processor and a memory. The processor is configured to receive a first message from a first control unit, among a plurality of control units grouped into a plurality of groups according to whether the control units are configured to use messages to which a protocol associated with vehicle functional safety is applied. The first control unit is included in a first group among the plurality of groups and the first message is based on the first group. The processor is also configured to change the first message to a second message based on a second group different from the first group, when transmitting the first message to a second control unit included in the second group.

### CROSS-REFERENCE TO RELATED APPLICATION

This application claims the benefit of and priority to Korean Patent Application No. 10-2024-0036657, filed on Mar. 15, 2024, the entire contents of which are hereby incorporated herein by reference.

### TECHNICAL FIELD

The present disclosure relates generally to a vehicle control apparatus and a method thereof, and more particularly, relates to technologies for setting routing between control units.

### BACKGROUND

A gateway may mediate communication between a plurality of control units in a vehicle and may efficiently manage data exchange. The plurality of control units may be grouped for each domain according to their functions and/or purposes. The plurality of control units may generate a message based on automotive open system architecture (AUTOSAR) capable of detecting a defect in data transmission. The AUTOSAR may indicate standardized open system architecture for automotive software architecture. The AUTOSAR is developed to improve integration and interoperability between electronic control units of a vehicle. The AUTOSAR is developed to cause integration of software between various car manufacturers and third-party suppliers. The gateway may perform a function of delivering a message between different domains.

### SUMMARY

The present disclosure has been made to solve the above-mentioned problems occurring in the prior art while advantages achieved by the prior art are maintained intact.

Aspects of the present disclosure provide a vehicle control apparatus for setting routing between control units and a method thereof.

Other aspects of the present disclosure provide a vehicle control apparatus for checking whether control units use an E2E protocol and a method thereof.

Further aspects of the present disclosure provide a vehicle control apparatus for changing header data included in a message and a method thereof.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, a vehicle control apparatus is provided. The vehicle control apparatus includes a memory configured to store instructions and a processor configured to execute the instructions. The processor is configured to receive a first message from a first control, among a plurality of control units grouped into a plurality of groups according to whether the control units are configured to use messages to which a protocol associated with vehicle functional safety is applied. The first control unit is included in a first group among the plurality of groups, and the first message is based on the first group. The processor is configured to change the first message to a second message based on a second group, among the plurality of groups, different from the first group, when transmitting the first message to a second control unit included in the second group.

In an embodiment, the processor may be configured to transmit, to the plurality of control units, a broadcasting signal for checking whether the control units are configured to use messages to which the protocol associated with vehicle functional safety is applied. The processor may also be configured to receive, from each of at least some of the plurality of control units, a response signal indicating whether a control unit from which the response signal is received is configured to use messages to which the protocol associated with vehicle functional safety is applied. The processor may further be configured to update a routing table including information about messages to be generated for communication between the plurality of control units, based on receiving the response signal. The processor may be configured to change the first message to the second message using the updated routing table.

In an embodiment, the information about messages to be generated for communication between the plurality of control units may include at least one of a type of a protocol corresponding to the message, a position at which message data indicating the type of the protocol is to be disposed in the message, consistency between control units associated with the message, or any combination thereof.

In an embodiment, the processor may be configured to transmit the broadcasting signal to the plurality of control units in response to identifying that a vehicle equipped with the vehicle control apparatus is in an ignition on state.

In an embodiment, the processor may be configured to add message data corresponding to the protocol associated with vehicle functional safety to at least a portion of the first message to change the first message to the second message, when transmitting the first message received from the first control unit configured to use messages to which the protocol associated with vehicle functional safety is not applied to the second control unit configured to use messages to which the protocol associated with vehicle functional safety is applied.

In an embodiment, the processor may be configured to change first message data corresponding to a first protocol associated with vehicle functional safety, the first message data being included in the first message, to second message data corresponding to a second protocol associated with vehicle functional safety to change the first message to the second message, when transmitting the first message received from the first control unit configured to use messages to which the first protocol is applied to the second control unit configured to use messages to which the second protocol is applied.

In an embodiment, the processor may be configured to change a position corresponding to the first message data included in the first message, in a data field of the first message, to another position corresponding to the second message data to change the first message to the second message.

In an embodiment, the first message data may include at least one of cyclic redundancy code (CRC) information for verifying integrity of the first message, counter information indicating an order of the first message, or any combination thereof.

In an embodiment, the processor may be configured to refrain from changing the first message, when transmitting the first message to a third control unit included in the first group.

In an embodiment, the protocol associated with the vehicle functional safety may comprise an end to end (E2E) protocol based on automotive open system architecture (AUTOSAR).

According to another aspect of the present disclosure, a vehicle control method is provided. The vehicle control method includes receiving a first message from a first control unit, among a plurality of control units grouped into a plurality of groups according to whether the control units are configured to use messages to which a protocol associated with vehicle functional safety is applied. The first control unit is included in a first group among the plurality of groups, and the first message is based on the first group. The vehicle control method also includes changing the first message to a second message based on a second group, among the plurality of groups, different from the first group, when transmitting the first message to a second control unit included in the second group.

In an embodiment, the vehicle control method may further include transmitting, to the plurality of control units, a broadcasting signal for checking whether to use the message to which the protocol associated with the vehicle functional safety is applied. The vehicle control method may also include receiving, from each of at least some of the plurality of control units, a response signal indicating whether a control unit from which the response signal is received is configured to use the message to which the protocol associated with the vehicle functional safety is applied. The vehicle control method may further include updating a routing table including information about messages to be generated for communication between the plurality of control units, based on receiving the response signal. Changing the first message to the second message may include changing the first message to the second message using the updated routing table.

In an embodiment, the information about messages to be generated for communication between the plurality of control units may include at least one of a type of a protocol corresponding to the message, a position at which message data indicating the type of the protocol is to be disposed in the message, consistency between control units associated with the message, or any combination thereof.

In an embodiment, transmitting the broadcasting signal to the plurality of control units may include transmitting the broadcasting signal to the plurality of control units in response to identifying that a vehicle in which the vehicle control method being performed is in an ignition on state.

In an embodiment, changing the first message to the second message may include adding message data corresponding to the protocol associated with vehicle functional safety to at least a portion of the first message to change the first message to the second message, when transmitting the first message received from the first control unit configured to use messages to which the protocol associated with vehicle functional safety is not applied to the second control unit configured to use messages to which the protocol associated with the vehicle functional safety is applied.

In an embodiment, changing the first message to the second message may include changing first message data corresponding to a first protocol associated with the vehicle functional safety, the first message data being included in the first message, to second message data corresponding to a second protocol associated with vehicle functional safety to change the first message to the second message, when transmitting the first message received from the first control unit configured to use messages to which the first protocol is applied to the second control unit configured to use messages to which the second protocol is applied.

In an embodiment, changing the first message to the second message may include changing a position corresponding to the first message data included in the first message, in a data field of the first message, to another position corresponding to the second message data to change the first message to the second message.

In an embodiment, the first message data may include at least one of cyclic redundancy code (CRC) information for verifying integrity of the first message, counter information indicating an order of the first message, or any combination thereof.

In an embodiment, the vehicle control method may further include refraining from changing the first message, when transmitting the first message to a third control unit included in the first group.

In an embodiment, the protocol associated with vehicle functional safety may comprise an end to end (E2E) protocol based on automotive open system architecture (AUTOSAR).

### BRIEF DESCRIPTION OF THE DRAWINGS

The above and other objects, features, and advantages of the present disclosure should be more apparent from the following detailed description taken in conjunction with the accompanying drawings, in which:

FIG. 1 illustrates an example of a block diagram associated with a vehicle control apparatus according to an embodiment of the present disclosure;

FIG. 2 illustrates an example of groups for dividing a plurality of control units connected with a vehicle control apparatus according to an embodiment of the present disclosure;

FIG. 3 illustrates an example of a routing table for identifying a message in a vehicle control apparatus according to an embodiment of the present disclosure;

FIGS. 4A and 4B illustrate an example of an operation for changing a message in a vehicle control apparatus according to an embodiment of the present disclosure;

FIG. 5 illustrates an example of a signal sequence diagram between a vehicle control apparatus and a plurality of control units according to an embodiment of the present disclosure;

FIG. 6 illustrates an example of a flowchart illustrating an operation of a vehicle control apparatus according to an embodiment of the present disclosure;

FIG. 7 illustrates an example of a flowchart illustrating a vehicle control method according to an embodiment of the present disclosure; and

FIG. 8 illustrates a computing system associated with a vehicle control apparatus or a vehicle control method according to an embodiment of the present disclosure.

### DETAILED DESCRIPTION

Hereinafter, embodiments of the present disclosure are described in detail with reference to the accompanying drawings. In adding the reference numerals to the components of each drawing, it should be noted that the identical components are designated by the identical numerals even when the components are displayed on different drawings. In addition, a detailed description of well-known features or functions has been omitted where it was determined that the detailed description would unnecessarily obscure the gist of the present disclosure.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. The expression “at least one of A, B, C, or any combination thereof” may include, for example, “A”, “B”, or “C”, or “AB”, “BC”, “AC”, or “ABC”, which is a combination thereof.

Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present disclosure.

The term “module” used in the present disclosure may include a unit implemented with hardware, software, and/or firmware, and may be interchangeably used with terms, for example, “logic,” “logic block,” “part,” or “circuitry”. A module may be an integral part, or a minimum unit or portion thereof, adapted to perform one or more functions. In an embodiment, the module may be implemented in the form of an application-specific integrated circuit (ASIC). According to various embodiments, operations performed by the module, the program, or another component may be carried out sequentially, in parallel, or repeatedly, or one or more of the operations may be executed in a different order or omitted, or one or more other operations may be added.

Various embodiments of the present disclosure may be implemented as software (e.g., a program) including one or more instructions stored in a storage medium (e.g., an internal memory or an external memory) readable by a machine (e.g., a vehicle control device 100 described in more detail below). For example, a processor (e.g., a processor 110 described in more detail below) of the device (e.g., the vehicle control device 100) may read at least one of the stored one or more instructions from the storage medium and may execute it. This allows the machine to be operated to perform at least one function according to the at least one instruction read from the memory. The one or more instructions may include a code generated by a complier or a code executable by an interpreter or a processor. The machine-readable storage medium may be provided in the form of a non-transitory storage medium. The term “non-transitory” means that the storage medium is a tangible device and does not include a signal (e.g., an electromagnetic wave). This term does not differentiate between where data is semi-permanently stored in the storage medium and where data is temporarily stored in the storage medium.

When a component, device, element, or the like of the present disclosure is described as having a purpose or performing an operation, function, or the like, the component, device, or element should be considered herein as being “configured to” meet that purpose or perform that operation or function.

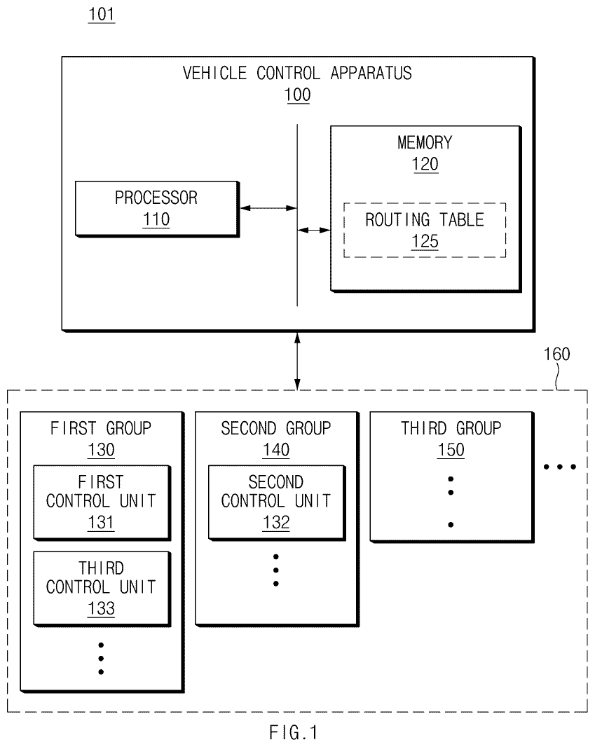

Hereinafter, embodiments of the present disclosure are described in detail with reference to FIGS. 1-8.

FIG. 1 illustrates a block diagram of a system that includes a vehicle control apparatus according to an embodiment of the present disclosure.

Referring to FIG. 1, a vehicle control apparatus 100 according to an embodiment of the present disclosure may be implemented inside or outside a vehicle. In some embodiments, some of components included in the vehicle control apparatus 100 may be implemented inside or outside the vehicle. In embodiments, the vehicle control apparatus 100 may be integrally configured with control units in the vehicle or may be implemented as a separate device to be connected with the control units of the vehicle by a separate connection means. In some embodiments, the vehicle control apparatus 100 may further include components that are not shown in FIG. 1. In an example, the vehicle control apparatus 100 (or a processor 110 of the vehicle control apparatus 100) may control driving of the vehicle, using one or more control units (e.g., a plurality of control units 160).

Referring to FIG. 1, in an embodiment, a vehicle control system 101 may include the vehicle control apparatus 100 according to an embodiment, and/or the plurality of control units 160. In terms of controlling autonomous driving of the vehicle, the vehicle control system 101 may be referred to as an autonomous driving system.

The vehicle control apparatus 100 according to an embodiment may include at least one of the processor 110 or a memory 120. The processor 110 and the memory 120 may be electronically or operably coupled with each other by an electronical component such as a communication bus. In various embodiments, the pieces of hardware that are described herein as being operably coupled with each other may be coupled with each other via a direct connection or an indirect connection in a wired or wireless manner, such that second hardware may be controlled by first hardware among the pieces of hardware. The pieces of hardware described herein are illustrated as different blocks. However, embodiments of the present disclosure are not limited thereto. For example, some of the pieces of hardware of FIG. 1 (e.g., at least some of the processor 110, the memory 120, and a communication circuit (not shown)) may be included in a single integrated circuit such as a system on a chip (SoC). The vehicle control apparatus 100 may be a gateway configured to establish a communication link (or set routing) between the plurality of control units 160 and/or manage the plurality of control units 160.

The processor 110 of the vehicle control apparatus 100 according to an embodiment may include hardware for processing data based on one or more instructions. The hardware for processing the data may include, for example, an arithmetic and logic unit (ALU), a floating point unit (FPU), a field programmable gate array (FPGA), a central processing unit (CPU), a micro controlling unit (MCU), and/or an application processor (AP). The processor 110 may include one or more processors. For example, the processor 110 may have a structure of a multi-core processor such as a dual core, a quad core, or a hexa core. Operations described below may be performed by the processor 110.

The memory 120 of the vehicle control apparatus 100 according to an embodiment may include a hardware component for storing data and/or an instruction input and/or output from the processor 110. The memory 120 may include, for example, a volatile memory, such as a random-access memory (RAM), and/or a non-volatile memory, such as a read-only memory (ROM). The volatile memory may include at least one of, for example, a dynamic RAM (DRAM), a static RAM (SRAM), a cache RAM, or a pseudo SRAM (PSRAM). The non-volatile memory may include at least one of, for example, a programmable ROM (PROM), an erasable PROM (EPROM), an electrically erasable PROM (EEPROM), a flash memory, a hard disk, a compact disc, a solid state drive (SSD), or an embedded multi-media card (eMMC).

In an embodiment, the plurality of control units 160 may cause driving of at least a part of the vehicle equipped with the vehicle control device 100 according to an embodiment. For example, the plurality of control units 160 may be electronic control units configured to manage electronic devices in the vehicle. The electronic control unit may include an engine control unit, a transmission control unit (TCU), and/or electronic stability control (ESC), depending on a type of an electronic device controllable by the electronic control unit.

In an embodiment, the plurality of control units 160 may be grouped according to whether to use a message to which a protocol associated with vehicle functional safety is applied.

For example, the protocol associated with the vehicle functional safety may include an end to end (E2E) protocol based on the automotive open system architecture (AUTOSAR). For example, the protocol associated with the vehicle functional safety may have a predetermined specification following ISO 26262 indicating an international standard about the vehicle functional safety. In an example, the AUTOSAR may include information for detecting a defect (e.g. tampering, repetition, or omission) in data (or a message) transmitted or received between the plurality of control units 160.

In an embodiment, the plurality of control units 160 may be grouped according to the purpose of controlling at least one function of the vehicle. For example, groups of the plurality of control units 160 may include domain groups, in terms of being grouped according to at least one function. The domain groups may include a chassis domain, an autonomous driving domain, and/or an aftermarket domain.

For example, a first group 130 may include a local product (LP) control unit, where LP may refer to being produced in the country where the vehicle is manufactured. A second group 140 may include a knock down (KD) control unit. A third group 150 may include an aftermarket control unit.

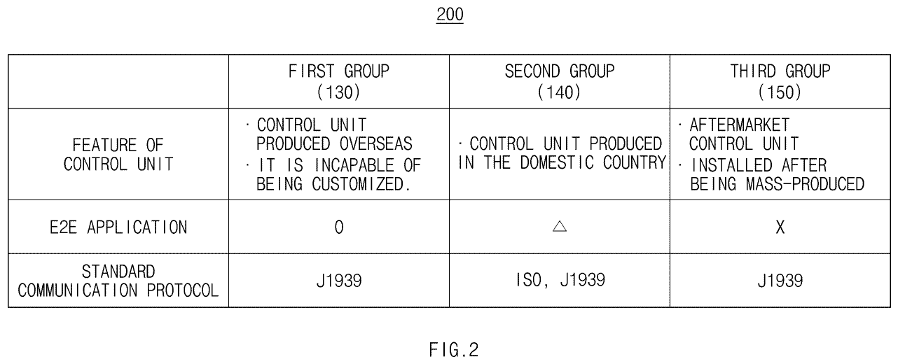

In an embodiment, the plurality of control units 160 may be divided according to a type (e.g., profile 2 or profile 5) of an end to end (E2E) protocol usable by each of the plurality of control units 160. The groups of the plurality of control units 160, according to embodiments, are described in more detail below with reference to FIG. 2.

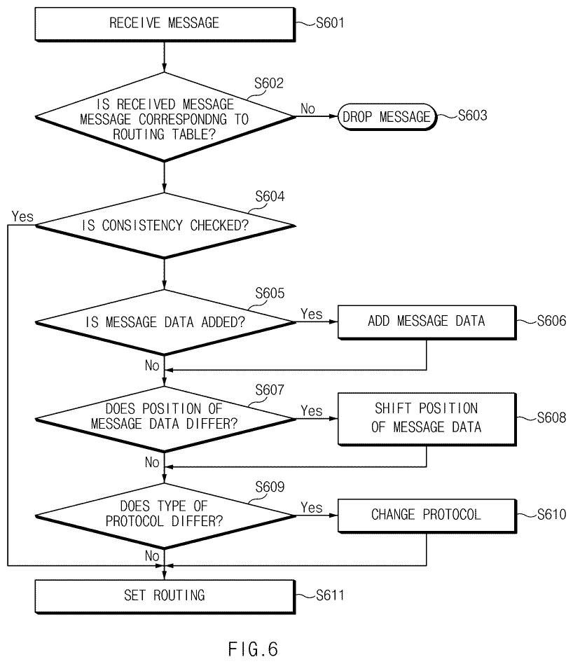

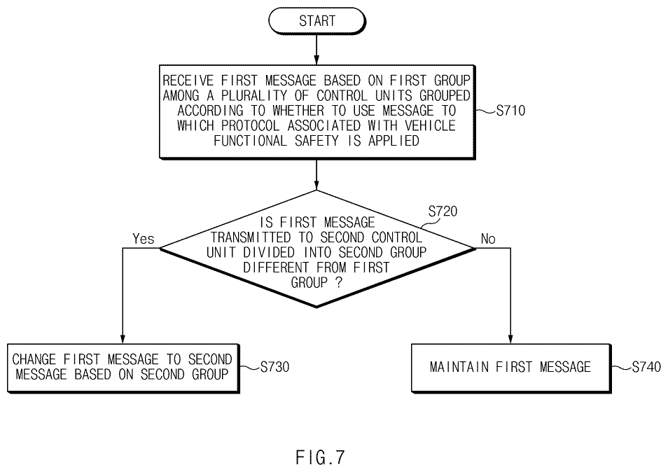

One or more instructions indicating calculation and/or an operation to be performed for data by the processor 110 may be stored in the memory 120 of the vehicle control apparatus 100 according to an embodiment. A set of the one or more instructions may be referred to as firmware, an operating system, a process, a routine, a sub-routine, and/or an application. For example, if a set of a plurality of instructions distributed in the form of an operating system, firmware, a driver, and/or an application is executed, the vehicle control apparatus 100 and/or the processor 110 may perform at least one of operations described in more detail below with reference to FIGS. 6 and 7.

In the present disclosure, when it is described that software in the form of an operating system, firmware, a driver, and/or an application is installed in the vehicle control apparatus 100, this may mean that one or more instructions provided in the form of software are stored in the memory 120 of the vehicle control apparatus 100. For example, one or more applications may be stored in the memory 120 in a format executable by the processor 110 of the vehicle control apparatus 100 (e.g., as a file with an extension specified by an operating system of the vehicle control apparatus 100).

The vehicle control apparatus 100 according to an embodiment may receive a first message based on the first group 130. The first message may be received, for example, from the first control unit 131 of the first group 130 among the plurality of control units 160 grouped according to whether the control units are configured to use messages to which the protocol associated with the vehicle functional safety is applied. The first message may include information for a control unit to cause an operation of another control unit.

In an example, control units (e.g., the first control unit 131 or a third control unit 133) of the first group 130 may be control units that are configured to generate a message based on a first protocol.

In an example, the first message based on the first group 130 may include a message set based on a type (e.g., profile 2 or profile 5) of a protocol corresponding to the first group 130.

When transmitting the first message to a second control unit 132 of a second group 140 different from the first group 130, the vehicle control apparatus 100 according to an embodiment may change the first message to a second message based on the second group 140.

For example, control units (e.g., the second control unit 132) of the second group 140 may be control units that are configured to generate a message based on a second protocol.

In an example, the second message based on the second group 140 may include a message generated based on a type of a protocol corresponding to the second group 140.

In an example, the second message based on the second group 140 may include information that is substantially the same as the first message.

The vehicle control apparatus 100 according to an embodiment may transmit a broadcasting signal to the plurality of control units 160, based on identifying that the vehicle equipped with the control apparatus 100 is in an ignition on state.

The vehicle control apparatus 100 according to an embodiment may transmit the broadcasting signal to the plurality of control units 160 to check whether the control units are configured to use messages the protocol associated with the vehicle functional safety is applied.

The vehicle control apparatus 100 according to an embodiment may receive, from each of at least some of the plurality of control units 160, a response signal indicating whether the control unit from which the response signal is received is configured to use messages to which the protocol associated with the vehicle functional safety is applied.

For example, the response signal may include a type of the protocol and/or a position assigned to message data (or header data) following the type of the protocol, in the data field of the message. The response signal may be transmitted from a control unit 160, among the plurality of control units 160, to the vehicle control apparatus 100 as a unicast message.

The vehicle control apparatus 100 according to an embodiment may update a routing table 125 including information about messages to be generated for communication between the plurality of control units 160, based on receiving the response signal.

For example, the routing table 125 may include identification information of a message, information (e.g., group information, channel information, or domain information) of a control unit that transmits the message, a period for transmitting the message, and/or information (e.g., group information, channel information, or domain information) of a control unit that is to receive the message.

For example, the information about messages to be generated for communication between the plurality of control units 160 may include at least one of a type of a protocol corresponding to a message, a position at which message data indicating the type of the protocol is to be disposed in the message (or a position assigned to the message data), consistency between control units associated with the message, or any combination thereof.

In an example, the type of the protocol corresponding to the message may be divided according to a predetermined specification.

In an example, the position at which the message data (e.g., the header data) is to be disposed may indicate a position to which the message data is assigned in the message data field.

In an example, the consistency between the control units associated with the message may indicate whether protocols usable by control units which transmit the message or receive the message are the same as each other.

In an example, the vehicle control apparatus 100 may add the information about the message to be generated for communication between the plurality of control units 160 to the routing table 125 to update the routing table 125.

The vehicle control apparatus 100 according to an embodiment may change the first message based on the first group 130 to the second message based on the second group 140, using the updated routing table.

If transmitting the first message based on the first group 130 to the third control unit 133 included in the first group 130, the vehicle control apparatus 100 according to an embodiment may refrain from changing the first message. In an example, the vehicle control apparatus 100 may drop the first message. In an example, the vehicle control apparatus 100 may transmit the first message to the third control unit 133 without change.

In an embodiment, in response to identifying the message corresponding to the routing table 125, the vehicle control apparatus 100 may transmit the message to another control unit. On the other hand, if the message received from the first control unit 131 does not correspond to the routing table 125, the vehicle control apparatus 100 may drop the message received from the first control unit 131. In an example, if the message received from the first control unit 131 corresponds to the routing table 125, the vehicle control apparatus 100 may check the second control unit 132 in which the message is to be received using the routing table 125. The vehicle control apparatus 100 may transmit the message to the second control unit 132.

In an embodiment, the operation in which the vehicle control apparatus 100 transmits the message received from the first control unit 131 to the second control unit 132 may be referred to as a message routing operation.

As described above, the vehicle control apparatus 100 may solve the problem of developing specifications of control units, which may occur when performing communication based on the E2E message to apply the vehicle functional safety. The vehicle control device 100 may collect E2E information of control units (a type of a protocol usable by the control units) when a network is initialized (e.g., when the vehicle equipped with the control apparatus is in an ignition on state), thus processing messages generated by a control unit mounted after the vehicle is mass-produced (e.g., a control unit included in the third group 150). In an example, the vehicle control apparatus 100 may identify consistency of control units that transmit/receive the message. For example, the vehicle control apparatus 100 may perform routing for all of the plurality of control units, thus resulting in a cost savings effect as compared to unifying protocols usable by the plurality of control units.

FIG. 2 illustrates an example of groups for dividing a plurality of control units connected with a vehicle control apparatus according to an embodiment of the present disclosure.

Referring to FIG. 2, a table 200 illustrates an example including groups for dividing a plurality of control units (e.g., the plurality of control units 160 of FIG. 1).

Referring to the table 200, at least one of the plurality of control units may be included in a first group 130, at least one of the plurality of control units may be included in a second group 140, and/or at least one of the plurality of control units may be included in a third group 150.

In an embodiment, the plurality of control units may be grouped according to specifications (or features) of the control units.

For example, the control unit included in the first group 130 may include a control unit produced overseas or a control unit that is not configured (or incapable of being customized) to be suitable for a vehicle on which the control unit is to be mounted. For example, the control unit included in the first group 130 may include a control unit to which an E2E technology is previously applied according to a design of a company which produces the control unit.

For example, the first group 130 may be referred to as a chassis domain (e.g., a chassis-controller area network (C-CAN)). For example, the first group 130 may include motor assist hydraulic steering (MAHS), an electric brake system (EBS), and/or electro-hydraulic power steering (EHPS).

For example, the control unit included in the second group 140 may include a control unit produced in the domestic country. For example, the domestic country may include a country which produces a vehicle including the vehicle control apparatus 100. However, the present disclosure is not limited thereto.

For example, the second group 140 may be referred to as an autonomous driving domain (e.g., an E-CAN).

For example, the control unit included in the second group 140 may include a control unit capable of being configured (capable of being customized) to be suitable for the vehicle.

For example, the control unit included in the third group 150 may include an aftermarket control unit. The aftermarket control unit may include a digital tachograph (DTG) control unit and/or an electric power take-off (ePTO) control unit. For example, the control unit included in the third group 150 may be mounted after the vehicle is mass-produced.

For example, the third group 150 may be referred to as an aftermarket domain.

In an embodiment, the plurality of control units may be divided according to whether the control units are configured to use messages to which a protocol is applied.

For example, the control unit included in the first group 130 may include a control unit configured to use messages to which an E2E protocol is applied.

For example, at least some of the control units included in the second group 140 may include a control unit configured to use messages to which the E2E protocol is applied. In an example, the other control units included in the second group 140 may include a control unit configured to use messages to which the E2E protocol is not applied.

For example, the control unit included in the third group 150 may include a control unit configured to use messages regardless of the application of the E2E protocol.

In an embodiment, the control unit included in the first group 130 among the plurality of control units may include a control unit configured to follow at least one (e.g., J1939) of standard communication protocols.

In an embodiment, the control unit included in the second group 140 among the plurality of control units may include a control unit configured to follow at least one (e.g., ISO or J1939) of the standard communication protocols.

In an embodiment, the control unit included in the third group 150 among the plurality of control units may include a control unit configured to follow at least one (e.g., J1939) of the standard communication protocols. However, the present disclosure is not limited thereto.

As described above, a vehicle control apparatus (e.g., the vehicle control apparatus 100 of FIG. 1) according to an embodiment may group a plurality of control units (e.g., the plurality of control units 160 of FIG. 1) to check consistency between the plurality of control units.

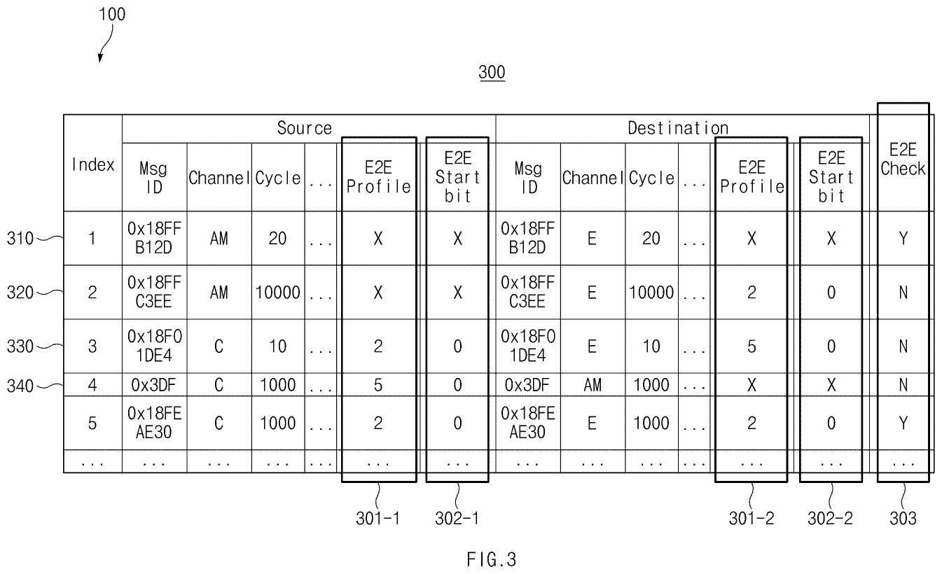

FIG. 3 illustrates an example of a routing table for identifying a message in a vehicle control apparatus according to an embodiment of the present disclosure.

Referring to FIG. 3, a routing table 300 may correspond to the routing table 125 included in the vehicle control apparatus 100 of FIG. 1, in an embodiment.

Referring to the table 300, the vehicle control apparatus 100 according to an embodiment may include a routing table, such as the routing table 300, associated with a plurality of control units (e.g., the plurality of control units 160 of FIG. 1).

The routing table 300 may include information (e.g., a source of FIG. 3) of a control unit that transmits a message and/or information (e.g., a destination of FIG. 3) of a control unit that is to receive the message.

In an embodiment, the routing table 300 may include identification information (e.g., a Msg ID of FIG. 3) of the message, group information (e.g., a channel of FIG. 3) of a control unit that transmits (or that is to receive) the message, and/or time information (e.g., a cycle of FIG. 3) for transmitting (or receiving) the message.

If a network is initialized (e.g., if the vehicle is equipped with the vehicle control apparatus 100 is an ignition on state), the vehicle control apparatus 100 according to an embodiment may request, from the plurality of control units, information about messages to be generated for communication between the plurality of control units.

For example, the vehicle control apparatus 100 may transmit, to the plurality of control units, a message to which a protocol associated with vehicle functional safety is applied.

In an example, the vehicle control apparatus 100 may receive a response signal from a control unit capable of using the message to which the protocol associated with the vehicle functional safety is applied.

On the other hand, the vehicle control apparatus 100 may fail to receive a response signal from a control unit which does not use the message to which the protocol associated with the vehicle functional safety is applied.

The vehicle control apparatus 100 according to an embodiment may update the routing table using the information about the message to be generated between the plurality of control units.

For example, the information about the messages to be generated for communication between the plurality of control units may include information indicating at least one of a type (e.g., an E2E profile 301-1 or 301-2 of FIG. 3) of a protocol corresponding to a message, a position (e.g., an E2E start bit 302-1 or 302-2 of FIG. 3) at which message data indicating the type of the protocol is to be disposed in the message, consistency (e.g., an E2E check 303 of FIG. 3) between control units associated with the message, or any combination thereof.

The vehicle control apparatus 100 according to an embodiment may identify information about a first message 310.

For example, a control unit that transmits the first message 310 may be configured to use messages to which the protocol associated with the vehicle functional safety is not applied.

Further, a control unit that is to receive the first message 310 may be configured to use messages to which the protocol associated with the vehicle functional safety is not applied.

Accordingly, because the control units associated with the first message 310 are configured to use messages to which the protocol associated with the vehicle functional safety is not applied, consistency between the control units associated with the first message 310 may be determined as being consistent.

The vehicle control apparatus 100 according to an embodiment may identify information about a second message 320.

For example, a control unit that transmits the second message 320 may be configured to use messages to which the protocol associated with the vehicle functional safety is not applied.

On the other hand, a control unit that is to receive the second message 320 may be configured to use messages to which the protocol associated with the vehicle functional safety is applied.

Accordingly, consistency between the control units associated with the second message 320 may be determined as being not consistent. Thus, when receiving the second message 320, the vehicle control apparatus 100 may change the second message 320 to another message to which the protocol associated with the vehicle functional safety is applied, before transmitting the second message 320.

The vehicle control apparatus 100 according to an embodiment may identify information about a third message 330.

For example, a control unit that transmit the third message 330 may be configured to use messages to which the protocol associated with the vehicle functional safety is applied.

Further, a control unit that is to receive the third message 330 may be configured to use messages to which the protocol associated with the vehicle functional safety is applied.

However, because a type (e.g., profile 2) of a protocol corresponding to the control unit that transmits the third message 330 is different from another type (e.g., profile 5) of a protocol corresponding to the control unit that is to receive the third message 330, consistency between the control unit that transmits the third message 330 and the control unit that is to receive the third message 330 may be determined as being not consistent. Thus, when receiving the third message 330, the vehicle control apparatus 100 may change the third message 330 based on the type of the protocol to another message based on another type of the protocol, before transmitting the third message 330.

The vehicle control apparatus 100 according to an embodiment may identify information about a fourth message 340.

For example, a control unit that transmits the fourth message 340 may be configured to use messages to which the protocol associated with the vehicle functional safety is applied.

On the other hand, a control unit that is to receive the fourth message 340 may be configured to use messages to which the protocol associated with the vehicle functional safety is not applied. Thus, consistency between the control unit that transmits the fourth message 340 and the control unit that is to receive the fourth message 340 may be determined as being not consistent.

When receiving the fourth message 340 from the control unit that transmits the fourth message 340, the vehicle control apparatus 100 according to an embodiment may change the fourth message 340 to which the protocol associated with the vehicle functional safety is applied to another message to which the protocol associated with the vehicle functional safety is not applied. However, the present disclosure is not limited thereto. For example, when receiving the fourth message 340 from the control unit that transmits the fourth message 340, the vehicle control apparatus 100 may refrain from the operation of changing the fourth message 340 to which the protocol associated with the vehicle functional safety is applied to the other message to which the protocol associated with the vehicle functional safety is not applied.

As described above, the vehicle control apparatus 100 according to an embodiment may update the routing table, thus enabling changing of a message generated by each of the plurality of control units to another message corresponding to the control unit that is to receive the message, using the updated routing table.

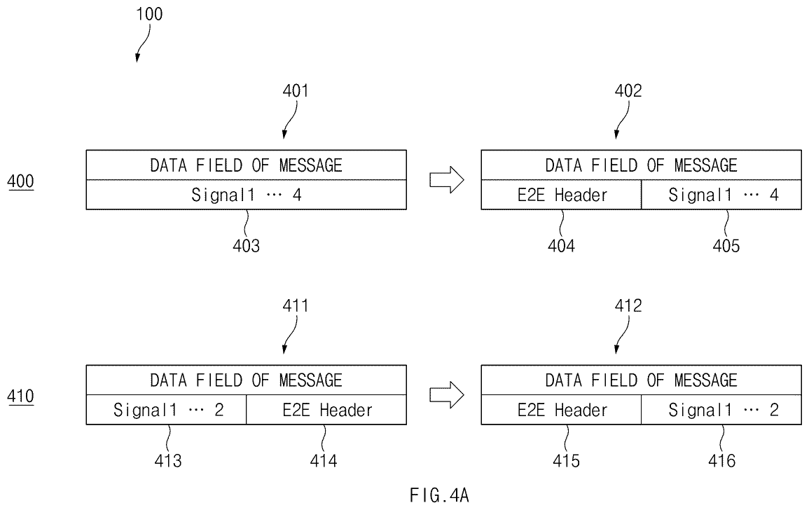

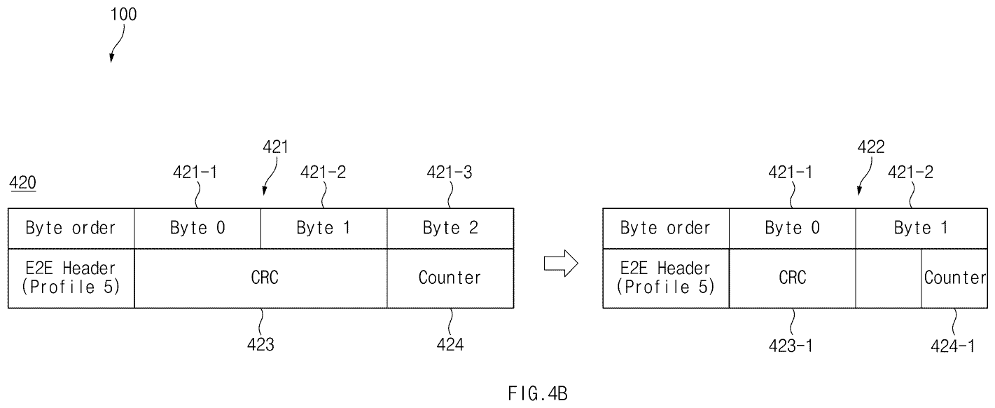

Hereinafter, a description is given in more detail of an example of an operation of changing a message using the routing table in the vehicle control apparatus 100, according to an embodiment, with reference to FIGS. 4A and 4B.

FIGS. 4A and 4B illustrate an example of an operation for changing a message in a vehicle control apparatus according to an embodiment of the present disclosure. In an embodiment, the vehicle control apparatus 100 of FIG. 1 may be configured to perform the operation described with reference to FIGS. 4A and 4B.

Referring to FIG. 4A, the vehicle control apparatus 100 according to an embodiment may obtain a message from at least one of a plurality of control units (e.g., the plurality of control units 160 of FIG. 1). The vehicle control apparatus 100 may check whether the message is matched with a routing table (e.g., the routing table 125 of FIG. 1). In an example, if the message is not matched with the routing table, the vehicle control apparatus 100 may drop the message. On the other hand, if the message is matched with the routing table, the vehicle control apparatus 100 may check consistency between a first control unit that transmitted the message and a second control unit that is to receive the message.

For example, the consistency between the first control unit that transmitted the message and the second control unit that is to receive the message is may be determined as being consistent when a protocol (or a type of the protocol) corresponding to the first control unit and a protocol (or a type of the protocol) corresponding to the second control unit are the same as each other.

In an example, if the consistency between the first control unit that transmitted the message and the second control unit that is to receive the message is determined as being not consistent, the vehicle control apparatus 100 may change the message obtained from the first control unit, based on the type of the protocol corresponding to the second control unit.

In an example 400, when transmitting a first message 401 received from the first control unit that is configured to use messages to which a protocol associated with vehicle functional safety is not applied to the second control unit that is configured to use messages to which the protocol associated with the vehicle functional safety is applied, the vehicle control apparatus 100 may add message data (e.g., header data) 404 corresponding to the protocol associated with the vehicle functional safety to at least a portion of the first message 401 (e.g., a portion of a data field of the first message 401), thus changing the first message 401 to a second message 402. A position at which the message data 404 is added in a data field of the second message 402 may vary with a type of a protocol corresponding to the second message 402.

For example, the data field may indicate one area in a memory which stores data.

In an embodiment, information 403 included in the first message 401 and information 405 included in the second message 402 may be the same as each other. In other words, the second message 402 may include the first message 401 and message data 404. In an embodiment, a position assigned to the information 403 included in the first message 401 in the data field may be different from a position assigned to the information 405 included in the second message 402.

In an embodiment, the message data 404 may include at least one of cyclic redundancy code (CRC) information for verifying integrity of the first message 401, counter information indicating an order of the first message 401, or any combination thereof.

In an example, the control unit that receives the second message 402 may check integrity of the first message 401, using the CRC information. In an example, the control unit that receives the second message 402 may check whether the second message 402 is a repeated message and/or there is an omitted message, using the information indicating an order of the first message.

In an embodiment, when transmitting the first message received from the first control unit that is configured to use messages to which a first protocol (e.g., profile 5) associated with the vehicle functional safety is applied to the second control unit that is configured to use messages to which a second protocol (e.g., profile 2) associated with the vehicle functional safety is applied, the vehicle control apparatus 100 according to an embodiment may change message data corresponding to the first protocol, which is included in the first message, to another message data corresponding to the second protocol, thus changing the first message to the second message.

Referring to an example 410, a position assigned to message data 414 included in the message to which the first protocol is applied and a position assigned to message data 415 included in the message to which the second protocol is applied may be different from each other.

For example, the vehicle control apparatus 100 may obtain a first message 411 from the first control unit that is configured to use messages to which the first protocol is applied. The first message 411 may include information 413 for causing an operation of the second control unit and the message data 414. A second message 412 may include information 416 corresponding to the information 413 and message data 415.

In an embodiment, the vehicle control apparatus 100 may change the first message 411 to the second message 412, by shifting the position of the message data.

The vehicle control apparatus 100 according to an embodiment may change a position corresponding to the message data 414 included in the first message 411, in the data field of the first message 411, to another position corresponding to the other message data 415, thus changing the first message 411 to the second message 412.

Referring to FIG. 4B, the vehicle control apparatus 100 according to an embodiment may receive a message for being transmitted to the second control unit that is configured to use messages based on the second protocol, from the first controller that is configured to use messages based on the first protocol.

In an example 420, the vehicle control apparatus 100 may check that the first protocol (E2E profile 5) and the second protocol (E2E profile 2) are different from each other, using the routing table. The vehicle control apparatus 100 may change the first message based on the first protocol to the second message based on the second protocol.

For example, the vehicle control apparatus 100 may change message data 421 in a message received from the first control unit configured to use message based on the first protocol to message data 422, thus obtaining the message based on the second protocol.

For example, CRC information 423 may be assigned to a first area 421-1 (e.g., first set of bits) and a second area 421-2 (e.g., second set of bits) of the message data 421 based on the first protocol. Counter information 424 may be assigned to a third area 421-3 (e.g., third set of bits) of the message data 421 based on the first protocol.

In an example, the vehicle control apparatus 100 may change the positions to which the CRC information 423 and the counter information 424 are assigned, based on a specification matched with the second protocol.

For example, the vehicle control apparatus 100 may assign CRC information 423-1 to the first area 421-1 and may assign counter information 424-1 to at least a portion of the second area 421-2, thus obtaining message data 422 different from the message data 421.

In an example, while maintaining the counter information 424, the vehicle control apparatus 100 may change the position assigned to the counter information 424 to a position assigned to the counter information 424-1.

In an example, the vehicle control apparatus 100 may calculate the CRC information 423 based on the AUTOSAR and may then update the position of the CRC information 423. For example, the vehicle control device 100 may calculate the CRC information calculated based on a specification (e.g., a number of CRC bits (e.g., 16 bits), a polynomial (e.g., 0x1021), a start position (e.g., 0xFFFF), and/or a logic value (e.g., 0x00)), which are/is defined by the first protocol (e.g., profile 5), based on a specification (e.g., a number of CRC bits (e.g., 8 bits), a polynomial (e.g., 0x2F), a start position (e.g., 0xFF), and/or a logic value (e.g., 0xFF)), which are/is defined by the second protocol (e.g., profile 2), thus obtaining the CRC information 423-1. However, the present disclosure is not limited thereto.

After changing the first message received from the first control unit to a second message to be transmitted to the second control unit, the vehicle control apparatus 100 according to an embodiment may perform message routing. For example, the vehicle control apparatus 100 may transmit the second message to a group including the second control unit, thus performing message routing.

As described above, the vehicle control apparatus 100 according to an embodiment may check consistency between the control unit that transmits the message and the control unit that is to receive the message, thus determining whether to change the message. The vehicle control apparatus 100 may determine whether to change the message using the routing table. The vehicle control apparatus 100 may change the message depending on the consistency between the control units, thus enabling message routing between control units that have different specifications.

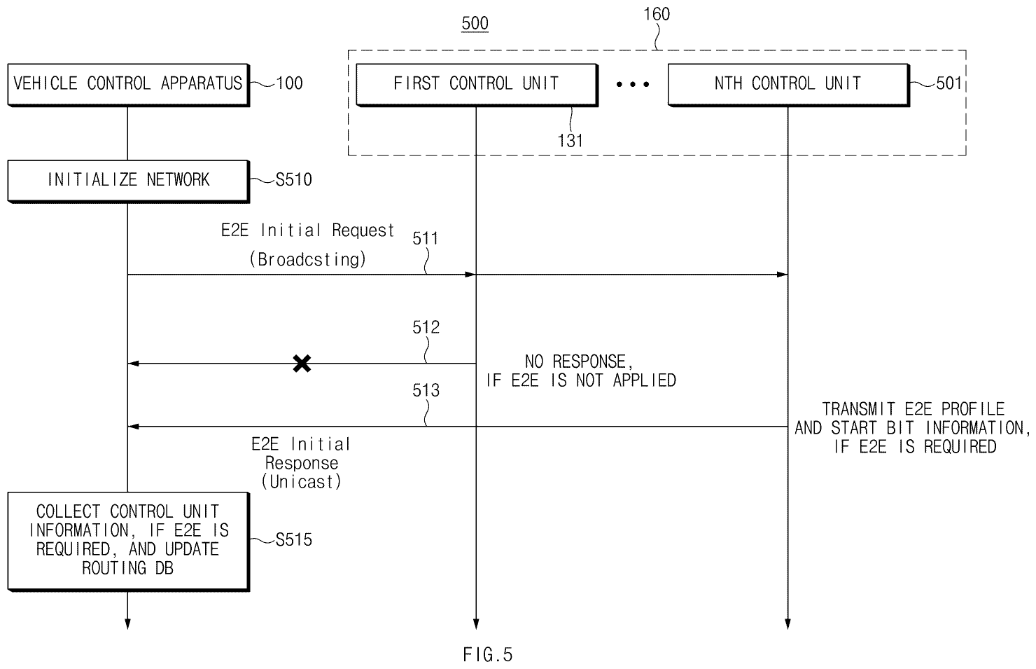

FIG. 5 illustrates a diagram of an example signal sequence between a vehicle control apparatus and a plurality of control units according to an embodiment of the present disclosure. The vehicle control apparatus 100 of FIG. 5 may correspond to the vehicle control apparatus 100 of FIG. 1. The plurality of control units 160 of FIG. 5 may correspond to the plurality of control units 160 of FIG. 1.

Referring to FIG. 5, in an operation S510, the vehicle control apparatus 100 according to an embodiment may perform network initialization. For example, the vehicle control apparatus 100 may perform the network initialization in response to identifying that the vehicle equipped with the vehicle control apparatus 100 is in an ignition on state. The vehicle control device 100 may perform the network initialization to update a routing table (e.g., the routing table 125 of FIG. 1).

The vehicle control apparatus 100 according to an embodiment may transmit a broadcasting signal 511 to the plurality of control units 160.

For example, the vehicle control apparatus 100 according to an embodiment may transmit a broadcasting signal for checking whether to use a message to which a protocol associated with vehicle functional safety is applied for communication with the plurality of control units 160.

The vehicle control apparatus 100 according to an embodiment may receive a response signal indicating whether to use the message to which the protocol associated with the vehicle functional safety is applied from each of at least some of the plurality of control units 160.

In an example, if a first control unit 131 is not configured to use messages to which the protocol associated with the vehicle functional safety is applied, the first control unit 131 may fail to transmit a response signal 512 to the vehicle control apparatus 100. In this case, the vehicle control apparatus 100 may determine that the first control unit 131 is not configured to us messages to which the protocol associated with the vehicle functional safety is applied.

In an embodiment, if an Nth control unit 501 is configured to use messages to which the protocol associated with the vehicle functional safety is applied, the Nth control unit 501 may transmit a response signal 513 to the vehicle control apparatus 100.

In an example, the response signal 513 may include information indicating a type of the protocol and/or a position assigned to message data.

In an operation S515, the vehicle control apparatus 100 according to an embodiment may collect pieces of information of control units configured to use messages to which the protocol is applied and may update a routing table using the pieces of collected information of the control units. For example, the vehicle control apparatus 100 may update the routing table to include information about messages to be generated for communication between the plurality of control units 160, based on receiving the response signal.

FIG. 6 illustrates a flowchart illustrating an example process that may be performed by a vehicle control apparatus according to an embodiment of the present disclosure. Hereinafter, it is assumed that a vehicle control apparatus 100 of FIG. 1 performs the process of FIG. 6. Furthermore, in the description of FIG. 6, an operation described as being performed by a vehicle control apparatus may be understood as being controlled by the processor 110 of the vehicle control apparatus 100. In other embodiments, a vehicle control apparatus different from the vehicle control apparatus 100 may perform the process of FIG. 6.

The respective operations of FIG. 6 may be sequentially performed, but are not necessarily sequentially performed. For example, an order of the respective operations may be changed and/or at least two operations may be performed in parallel. In an example, the vehicle control apparatus may perform operations below, using an updated routing table.

Referring to FIG. 6, in an operation S601, the vehicle control apparatus according to an embodiment may receive a message from a first control unit.

In an operation S602, the vehicle control apparatus according to an embodiment may check whether the received message is a message that matches information in a routing table.

In embodiment, if the received message is a message that does not match information in the routing table (No in the operation S602), in an operation S603, the vehicle control apparatus according to an embodiment may drop the message.

On the other hand, if the received message is a message that matches information in the routing table (Yes in the operation S602), in an operation S604, the vehicle control apparatus according to an embodiment may check consistency between the first control unit that transmitted the message and a second control unit that is to receive the message.

If the consistency between the first control unit and the second control unit is determined as being consistent (Yes in the operation S604), in an operation S611, the vehicle control apparatus according to an embodiment may perform message routing, without changing the message.

On the other hand, if the consistency between the first control unit and the second control unit is determined as being not consistent (No in the operation S604), in an operation S605, the vehicle control apparatus according to an embodiment may check whether to add message data.

If the message data should be added (Yes in the operation S605), in an operation S606, the vehicle control apparatus according to an embodiment may add the message data. An example in which the vehicle control apparatus adds the message data to a data field of the message, according to an embodiment, is described in more detail above with reference to the example 400 of FIG. 4A.

Referring still to FIG. 6, if the vehicle control apparatus performs the operation S606 or if the message data should not be added (No in the operation S605), in an operation S607, the vehicle control apparatus according to an embodiment may check whether a position of the message data differs.

Referring to FIG. 6, if the position of the message data differs (Yes in the operation S607), in an operation S608, the vehicle control apparatus according to an embodiment may shift the position of the message data. An example in which the vehicle control apparatus changes the position of the message data, according to an embodiment, is described in more detail above with reference to the example 410 of FIG. 4A.

Referring again to FIG. 6, if the vehicle control apparatus performs the operation S608 or if the position of the message data does not differ (No in the operation S607), in an operation S609, the vehicle control apparatus according to an embodiment may check whether a type of a protocol differs.

If the type of the protocol differs (Yes in the operation S609), in an operation S610, the vehicle control apparatus according to an embodiment may change the protocol. The vehicle control apparatus may thus obtain a message to which the changed protocol is applied. An example in which the vehicle control apparatus changes the protocol (or the type of the protocol) corresponding to the message, according to an embodiment, is described in more detail above with reference to the example 420 of FIG. 4B.

Referring again to FIG. 6, if the vehicle control apparatus performs the operation S610, if the type of the protocol does not differ (No in the operation S609), or if the consistency between the control units is determined as being consistent (Yes in the operation S604), in the operation S611, the vehicle control apparatus according to an embodiment may perform message routing. The vehicle control apparatus may transmit the message received from the first control unit to a group including the second control unit, thus performing message routing.

Hereinafter, a description is given in detail of a vehicle control method according to an embodiment of the present disclosure with reference to FIG. 7. FIG. 7 illustrates a flowchart illustrating an example vehicle control method according to an embodiment of the present disclosure.

Hereinafter, it is assumed that the vehicle control apparatus 100 of FIG. 1 performs a process of FIG. 7. Furthermore, in the description of FIG. 7, an operation described as being performed by a vehicle control apparatus may be understood as being controlled by the processor 110 of the vehicle control apparatus 100. In other embodiments, a vehicle control apparatus different from the vehicle control apparatus 100 may perform the method of FIG. 7.

The respective operations of FIG. 7 may be sequentially performed, but are not necessarily sequentially performed. For example, an order of the respective operations may be changed and/or at least two operations may be performed in parallel.

Referring to FIG. 7, the vehicle control method according to an embodiment may include an operation S710 of receiving a first message based on a first group from a first control unit, among a plurality of control units (e.g., the plurality of control units 160 of FIG. 1), of a first group, where the plurality of control units includes control unit grouped according to whether the control units are configured to use messages to which a protocol associated with vehicle functional safety is applied.

The vehicle control method according to an embodiment may include an operation S720 of checking whether the first message is to be transmitted to a second control unit of a second group different from the first group. A protocol that the first control unit of the first group is configured to use may be different from a protocol that the second control unit of the second group is configured to use.

The vehicle control method according to an embodiment may include an operation S730 of changing the first message to a second message based on the second group, when transmitting the first message to the second control unit in the second group different from the first group (Yes in the operation S720).

For example, the vehicle control method according to an embodiment may include transmitting, to the plurality of control units, a broadcasting signal for checking whether the control units are configured to use messages to which the protocol associated with the vehicle functional safety is applied.

In an example, the vehicle control method according to an embodiment may include receiving a response signal from each of at least some of the plurality of control units, the response signal indicating whether the control unit from which the response signal is received is configured to use messages to which the protocol associated with the vehicle functional safety is applied.

In an example, the vehicle control method may include updating a routing table including information about messages to be generated for communication between the plurality of control units, based on receiving the response signal.

In an example, the vehicle control method may include changing the first message to the second message, using the updated routing table.

The vehicle control method according to an embodiment may include adding message data in the first message to obtain the second message.

The vehicle control method according to an embodiment may include changing a position assigned to the message data included in the first message to obtain the second message.

The vehicle control method according to an embodiment may include changing the message data included in the first message to obtain the second message.

In an example, the vehicle control method may include transmitting the changed second message to the second control unit to perform message routing between the first control unit and the second control unit.

Referring to FIG. 7, the vehicle control method according to an embodiment may include an operation S740 of maintaining the first message when the first message is not to be transmitted to the second control unit of the second group different from the first group (No in the operation S720). The vehicle control method may also include transmitting the maintained first message to a control unit that is configured to receive messages consistent with the first message.

In an example, the vehicle control method may include maintaining the first message when transmitting the first message to a third control unit included in the first group.

In an example, because the third control unit included in the first group is configured to use the protocol used by the first control unit included in the first group, the vehicle control apparatus may refrain from changing the first message.

In an example, the vehicle control method may include transmitting the first message which is not changed to the third control unit to perform message routing between the first control unit and the third control unit.

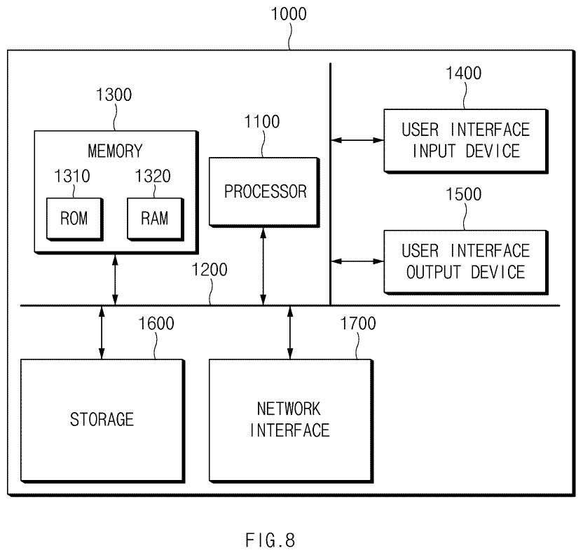

FIG. 8 illustrates a computing system associated with a vehicle control apparatus or a vehicle control method according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments of the present disclosure may be directly implemented with a hardware module, a software module, or a combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

Embodiments of the present disclosure may perform routing between control units.

Embodiments of the present disclosure may check whether the control units use an E2E protocol.

Furthermore, embodiments of the present disclosure may change header data included in the message.

In addition, various effects ascertained directly or indirectly through the present disclosure may be provided.

Hereinabove, although the present disclosure has been described with reference to several embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a memory configured to store instructions; and
a processor configured to execute the instructions, wherein the processor is configured to:
receive a first message from a first control unit, among a plurality of control units grouped into a plurality of groups according to whether the control units are configured to use messages to which a protocol associated with vehicle functional safety is applied, wherein the first control unit is included in a first group among the plurality of groups, and wherein the first message is based on the first group, and
change the first message to a second message based on a second group, among the plurality of groups, different from the first group, when transmitting the first message to a second control unit included in the second group.

2. The vehicle control apparatus of claim 1, wherein the processor is configured to:
transmit, to the plurality of control units, a broadcasting signal for checking whether the control units are configured to use messages to which the protocol associated with vehicle functional safety is applied;
receive, from each of at least some of the plurality of control units, a response signal indicating whether a control unit from which the response signal is received is configured to use messages to which the protocol associated with vehicle functional safety is applied;
update a routing table including information about messages to be generated for communication between the plurality of control units, based on receiving the response signal; and
change the first message to the second message using the updated routing table.

3. The vehicle control apparatus of claim 2, wherein the information about messages to be generated for communication between the plurality of control units includes at least one of a type of a protocol corresponding to a message, a position at which message data indicating the type of the protocol is to be disposed in the message, consistency between control units associated with the message, or any combination thereof.

4. The vehicle control apparatus of claim 2, wherein the processor is configured to transmit the broadcasting signal to the plurality of control units in response to identifying that a vehicle equipped with the vehicle control apparatus is in an ignition on state.

5. The vehicle control apparatus of claim 1, wherein the processor is configured to add message data corresponding to the protocol associated with vehicle functional safety to at least a portion of the first message to change the first message to the second message, when transmitting the first message received from the first control unit configured to use messages to which the protocol associated with vehicle functional safety is not applied to the second control unit configured to use messages to which the protocol associated with vehicle functional safety is applied.

6. The vehicle control apparatus of claim 1, wherein the processor is configured to change first message data corresponding to a first protocol associated with vehicle functional safety, the first message data being included in the first message, to second message data corresponding to a second protocol associated with vehicle functional safety to change the first message to the second message, when transmitting the first message received from the first control unit configured to use messages to which the first protocol is applied to the second control unit configured to use messages to which the second protocol is applied.

7. The vehicle control apparatus of claim 6, wherein the processor is configured to change a position corresponding to the first message data included in the first message, in a data field of the first message, to another position corresponding to the second message data to change the first message to the second message.

8. The vehicle control apparatus of claim 6, wherein the first message data includes at least one of cyclic redundancy code (CRC) information for verifying integrity of the first message, counter information indicating an order of the first message, or any combination thereof.

9. The vehicle control apparatus of claim 1, wherein the processor is configured to refrain from changing the first message, when transmitting the first message to a third control unit included in the first group.

10. The vehicle control apparatus of claim 1, wherein the protocol associated with vehicle functional safety comprises an end to end (E2E) protocol based on automotive open system architecture (AUTOSAR).

11. A vehicle control method, comprising:
receiving a first message based from a first control unit, among a plurality of control units grouped into a plurality of groups according to whether to the control units are configured to use messages to which a protocol associated with vehicle functional safety is applied, wherein the first control unit is included in a first group among the plurality of groups, and wherein the first message is based on the first group; and
changing the first message to a second message based on a second group, among the plurality of groups, different from the first group, when transmitting the first message to a second control unit included in the second group.

12. The vehicle control method of claim 11, further comprising:
transmitting, to the plurality of control units, a broadcasting signal for checking whether the control units are configured to use messages to which the protocol associated with vehicle functional safety is applied;
receiving, from each of at least some of the plurality of control units, a response signal indicating whether a control unit from which thew response signal is received is configured to use messages to which the protocol associated with vehicle functional safety is applied; and
updating a routing table including information about messages to be generated for communication between the plurality of control units, based on receiving the response signal,
wherein changing the first message to the second message including changing the first message to the second message using the updated routing table.

13. The vehicle control method of claim 12, wherein the information about the messages to be generated for communication between the plurality of control units includes at least one of a type of a protocol corresponding to a message, a position at which message data indicating the type of the protocol is to be disposed in the message, consistency between control units associated with the message, or any combination thereof.

14. The vehicle control method of claim 12, wherein transmitting the broadcasting signal to the plurality of control units includes transmitting the broadcasting signal to the plurality of control units in response identifying that a vehicle in which the vehicle control method is being performed is in an ignition on state.

15. The vehicle control method of claim 11, wherein changing the first message to the second message includes adding message data corresponding to the protocol associated with vehicle functional safety to at least a portion of the first message to change the first message to the second message, when transmitting the first message received from the first control unit configured to use messages to which the protocol associated with vehicle functional safety is not applied to the second control unit configured to use messages to which the protocol associated with vehicle functional safety is applied.

16. The vehicle control method of claim 11, wherein changing the first message to the second message includes changing first message data corresponding to a first protocol associated with vehicle functional safety, the first message data being included in the first message, to second message data corresponding to a second protocol associated with vehicle functional safety to change the first message to the second message, when transmitting the first message received from the first control unit configured to use messages to which the first protocol is applied to the second control unit configured to use messages to which the second protocol is applied.

17. The vehicle control method of claim 16, wherein changing the first message to the second message includes changing a position corresponding to the first message data included in the first message, in a data field of the first message, to another position corresponding to the second message data to change the first message to the second message.

18. The vehicle control method of claim 16, wherein the first message data includes at least one of cyclic redundancy code (CRC) information for verifying integrity of the first message, counter information indicating an order of the first message, or any combination thereof.

19. The vehicle control method of claim 11, further comprising refraining from changing the first message, when transmitting the first message to a third control unit included in the first group.

20. The vehicle control method of claim 11, wherein the protocol associated with vehicle functional safety comprises an end to end (E2E) protocol based on automotive open system architecture (AUTOSAR).
